(19) United States
(12) Patent Application Publication
(10) Pub. No.: US 2016/0146702 A1
(43) Pub. Date: May 26, 2016

(54) METHOD FOR DETECTING SURGE LEVEL IN VEHICLE

(71) Applicant: HYUNDAI MOTOR COMPANY, Seoul (KR)

(72) Inventors: Heung Seok LEE, Seoul (KR); Wan Soo OH, Yongin-si (KR)

(21) Appl. No.: 14/683,076

(22) Filed: Apr. 9, 2015

(30) Foreign Application Priority Data
Nov. 26, 2014 (KR) 10-2014-0166597

(51) Int. Cl. G01M 15/08; F02B 77/08

(52) U.S. Cl. CPC G01M 15/08; F02B 77/085

(57) ABSTRACT

A method for detecting a surge level in a vehicle based on a combustion pressure in a cylinder includes determining an IMEP parameter which determines stability of combustion according to a covariance of an IMEP. A PPP parameter, which varies the covariance of the IMEP and determines stability of combustion according to a variance in an angle of rotation of a crank when the combustion pressure reaches the highest point, is determined. A BD parameter, which varies both the the covariance of the IMEP and the angle of rotation of the crank and determines the stability of combustion according to a variance in the angle of rotation of the crank when a set range of amount of fuel is burned in the cylinder, is determined. An RPM parameter, which determines a surge level according to a variance in an RPM of an engine, is determined.

### CROSS REFERENCE TO RELATED APPLICATION

The present application claims the benefit of priority to Korean Patent Application Number 10-2014-0166597 filed on Nov. 26, 2014, the entire contents of which application are incorporated herein for all purposes by this reference.

### TECHNICAL FIELD

The present disclosure generally relates to a method for detecting a surge level of an internal combustion engine in a vehicle based on a combustion pressure. More particularly, the present disclosure relates to a method for providing a new index to estimate a variance in revolutions per minute (RPM) of an engine that occurs while a gasoline engine vehicle is running.

### BACKGROUND

A gasoline vehicle has variable valve timing apparatus in an internal combustion engine to increase the amount of internal exhaust gas recirculation (EGR) gas by increasing valve overlap. Accordingly, a pumping loss is decreased, and fuel efficiency may increase.

However, when the valve overlap excessively increases, the amount of internal EGR gas may rapidly increase, thus deteriorating combustion stability, knocking, and the like. Especially, when combustion stability deteriorates, operability problems such as a surge of a vehicle may cause. Therefore, the combustion stability is an important condition in determining the amount of valve overlap. Here, a surge means a front-back vibration occurring as a vibratory force of an engine excites a driving system of the vehicle when the engine is directly connected to a transmission.

In this case, the vibratory force of the engine is proportional to a variance in RPM of the engine. Therefore, it is necessary to decrease the variance in RPM of the engine to reduce the surge of the vehicle.

The variance in RPM of the engine is related to an output torque of the engine, and the output torque of the engine is related to a combustion pressure in a cylinder of the engine.

A conventional art uses a covariance of indicated mean effective pressure (IMEP) COV_{IMEP} to determine combustion stability, which is obtained from a statistical calculation of IMEP that represents the combustion pressure in the cylinder. The definition of COV_IMEP is as follows:

COV_{IMEP}(covariance of IMEP)=standard deviation of IMEP/mean of IMEP

However, when determining combustion stability based on the combustion pressure in a cylinder, the combustion stability does not correspond to a variance in RPM of the engine. As the COV_{IMEP} may not estimate the variance in RPM in an optimal level, it is difficult to establish a reference for the surge of the vehicle when developing the vehicle.

Additionally, the combustion stability may vary according to variation of an engine, an accumulated mileage of a vehicle, and the like. Therefore, using the COV_{IMEP} only according to the combustion pressure of a cylinder has a limit in estimating the variance in RPM of the engine that may represent a surge level of the vehicle.

Accordingly, the present disclosure provides a new index to detect a surge level in a vehicle. The index is based on a combustion pressure in a cylinder, but also considers parameters affecting the combustion pressure and parameters for measuring effects of an engine RPM.

The foregoing is intended merely to aid in the understanding of the background of the present disclosure, and is not intended to mean that the present disclosure falls within the purview of the related art that is already known to those skilled in the art.

### SUMMARY

An aspect of the present inventive concept provides an index that may accurately estimate a variance in RPM of an engine, capable of providing a baseline when developing a vehicle. In a vehicle developmental phase, the present disclosure aims at combustion stability that may reduce a surge using the index.

According to an exemplary embodiment of the present inventive concept, a method for detecting a surge level in a vehicle based on a combustion pressure in a cylinder includes determining an IMEP parameter which determines stability of combustion according to a covariance of an IMEP. A PPP parameter, which varies the covariance of the IMEP and determines the stability of combustion according to a variance in an angle of rotation of a crank when the combustion pressure reaches the highest point, is determined. A BD parameter, which affects both the covariance of an IMEP and the angle of rotation of the crank when the combustion pressure reaches the highest point and determines the stability of combustion according to the variance in the angle of rotation of the crank when a set range of amount of fuel is burned in the cylinder, is determined. An RPM parameter determines a surge level according to a variance in an RPM of an engine. According to the method for detecting a surge level in a vehicle based on a combustion pressure in a cylinder, a variance in engine RPM may be accurately estimated, and thus, it is possible to accurately implement consideration of combustion stability in developing a vehicle.

### BRIEF DESCRIPTION OF THE DRAWINGS

The above and other objects, features and other advantages of the present disclosure will be more clearly understood from the following detailed description taken in conjunction with the accompanying drawings.

FIG. 1 is a graph illustrating a variance in an index to a variance in RPM of a vehicle when changing ignition timing using the index of the present disclosure.

FIG. 2 is a graph illustrating a result when applying a lower limit of each parameter.

### DETAILED DESCRIPTION

Hereinafter, referring to accompanying drawings, a method for detecting a surge level in a vehicle based on a combustion pressure according to an exemplary embodiment of the present inventive concept will be described.

An aspect of the present inventive concept provides a new index to accurately estimate a variance in engine RPM based on a combustion pressure in a cylinder compared to the conventional art.

The present disclosure includes multiple parameters in the new index, which are correlated to the variance of the engine RPM, as follows:

[(IMEP parameter)+(PPP parameter)+(BD parameter)]×(RPM parameter)

Each of the parameters included in the index of the present disclosure will be described below.

First, an indicated mean effect pressure (IMEP) parameter is a parameter for a variance in the IMEP, which determines stability of combustion itself.

The IMEP parameter is implemented by the following Equation (1):

max{COV_{IMEP},COVₘᵢₙ}/COV_{thd})^{A} (1)

, where IMEP denotes a mean combustion pressure inside a cylinder; COV_{IMEP} denotes a variation coefficient of the IMEP; COVₘᵢₙ denotes a set minimum value of COV_{IMEP}; COV_{thd} denotes a set threshold value of COV_{IMEP}; and A denotes a weighted value that represents a degree of contribution of the IMEP parameter to a surge of a vehicle.

IMEP is the mean combustion pressure inside the cylinder, and COV_{IMEP} is obtained from a statistical calculation of the IMEP. COV_{IMEP} is defined as follows:

COV_{IMEP}=standard deviation of IMEP/mean of IMEP

The index according to the present invention includes the IMEP parameter because COV_{IMEP} is a parameter for determining stability of combustion itself, and the stability of combustion is related to a variance in engine torque, which is caused by the combustion.

The surge of a vehicle occurs due to non-uniformity of torque output from an engine. The torque output from the engine is estimated using torque from combustion and torque from an engine moving system as the following expression:

Torque output from engine=torque from combustion+torque from engine moving system

In this case, the torque from combustion is implemented by multiplying explosive force of the combustion by an effective radius of a crankshaft as the following expression:

torque from combustion=explosive force of combustion×effective radius of crankshaft

The present disclosure further includes peak cylinder pressure position (PPP) parameter, which determines the effective radius of the crankshaft, in the index according to the present disclosure, the effective radius of the crankshaft affecting estimation of torque from combustion.

The PPP parameter will be described in detail below.

The IMEP parameter as shown Equation (1) is included in the index according to the present disclosure. In Equation (1), COVₘᵢₙ is set to consider a situation in which the surge may occur even though a value measured when calculating the IMEP parameter is low compared to values of the PPP parameter and BD parameter. In other words, COVₘᵢₙ means a set minimum value of COV_{IMEP}.

When the values of the PPP parameter or the BD parameter are high, the surge may occur in the vehicle even though a value measuring COV_{IMEP} is low compared to a value of the PPP parameter or a value of the BD parameter. Therefore, if a lower limit of COV_{IMEP} is not set, a value measuring COV_{IMEP} may be low regardless of the PPP parameter and the BD parameter, and thus, the index value may be low. In other words, even though the surge may occur in the vehicle due to the PPP parameter and the BD parameter, the index may not represent a degree of occurrence of the surge because of a decrease of a IMEP parameter value. Accordingly, the COVₘᵢₙ may prevent the above case.

When developing a vehicle considering the index according to the present disclosure, a reference value of the index is set as 1. The value of the index more than 1 means that risk of occurrence of the surge is high while the value less than 1 means that the risk of occurrence of the surge is low.

If a value measuring COV_{IMEP} does not have a lower limit, the value of the index may be measured to be less than 1. However, practically, different from the value of the index, the risk of occurrence of a surge may be high due to the PPP parameter and the BD parameter.

COV_{thd} means a set threshold value of COV_{IMEP} to prevent occurrence of the surge. In other words, COV_{thd} is a guideline value to prevent occurrence of a surge in a vehicle and is an experimental value obtained from vehicle tests. Desirably, COV_{thd} may be set to 2.8.

Further, A used in the IMEP parameter, B used in the PPP parameter, C used in the BD parameter, and D and E used in the RPM parameter mean weighted values for the parameters according to a level of contribution that affects the surge in the vehicle.

Generally, the weighted values may be configured as PPP parameter>IMEP parameter>BD parameter. Desirably, the values are basically set as A=3, B=4, and C=1.5, but the values may be differently set according to the surge level of the engine.

The PPP parameter included in the index proposed by the present disclosure will be described as follows.

The PPP parameter affects COV_{IMEP}, and may determine stability of combustion itself according to a variance in an angle of rotation of a crank when a pressure in the cylinder reaches the highest point. In other words, when calculating torque form combustion, it is necessary to consider the effective radius of a crankshaft, and PPP is a parameter that determines the effective radius of the crankshaft. As the PPP parameter affects engine torque output, the present disclosure includes the PPP parameter in the index.

The PPP parameter is implemented by the following Equation (2):

(max{PPP,PPPₘᵢₙ}/PPP_{thd})^{B} (2)

, where PPP denotes the angle of rotation of the crank when a pressure inside the cylinder reaches the highest point; PPPₘᵢₙ denotes a set minimum value of PPP; PPP_{thd} denotes a set threshold value of PPP to prevent occurrence of the surge; and B denotes a weighted value that represent a degree of contribution of PPP to the surge in the vehicle.

PPPₘᵢₙ is a set minimum value of PPP, the reason why PPPₘᵢₙ is set is the same as the case of COVₘᵢₙ. That is, even though a value of PPP is low, a surge may occur in a vehicle due to other parameters. Therefore, due to the value of PPP, which is measured to be low, the index proposed by the present disclosure may be measured less than 1. Accordingly, PPPₘᵢₙ is necessary to prevent the above case.

In the case of COV_{thd}, PPP_{thd} is a guideline value to prevent occurrence of the surge in the vehicle, and is an experimental value obtained from vehicle tests. The value of PPP_{thd} may be set to 33 degrees.

Next, a burn duration (BD) parameter is described as follows.

The BD parameter is implemented by the following Equation (3):

(max{BD,BDₘᵢₙ}/BD_{thd})^{C} (3)

, where BD denotes a variance in the angle of rotation of a crank when a set range of amount of fuel is burned in a cylinder; BDₘᵢₙ denotes a set minimum value of BD; BD_{thd} denotes a threshold value of BD to prevent occurrence of a surge; and C means a weighted value that represents a degree of contribution of BD parameter to the surge in a vehicle.

In this case, the BD is a variance in an angle that the crank rotates from when the amount of fuel burned in the cylinder is 5% of the total amount of the fuel to when the amount of the fuel burned in the cylinder is 90% of the total amount of the fuel.

The BD parameter will be described in detail as follows.

The BD means angle of rotation of the crank from the point in which combustion occurs in the cylinder (5% of the total amount of fuel is burned) to the point in which the combustion is finished (90% of the total amount of fuel is burned).

In this case, as the value of BD is lower, PPP is advanced and COV_{IMEP} is improved. In other words, as the BD parameter affects IMEP parameter and PPP parameter, the index proposed by the present invention includes the BD parameter. Here, even though the value of BD is low, the surge may occur due to other parameters. Accordingly, a lower limit of the value of BD, BDₘᵢₙ is set. BD_{thd} is a guideline value and is an experimental value obtained from vehicle tests. The BD_{thd} may be set to 33 degrees.

The RPM parameter will be described hereinafter.

The RPM parameter considers a surge according to the variance in RPM of an engine.

Concretely, the RPM parameter is implemented by the following Equation (4):

D/n^{E} (4)

, where n denotes the RPM of an engine, and D, and E denote variables according to the engine.

The RPM parameter considers that values measuring the IMEP parameter, the PPP parameter, and the BD parameter decrease as the RPM of an engine is increased.

The RPM parameter is included in the index proposed by the present disclosure so that the index is commonly used. In other words, when developing a vehicle considering the index, a reference of the index is set to 1 to provide a uniform development baseline for the RPM of an engine of every vehicle.

In case of the surge of a vehicle, as engine RPM increases, the degree of occurrence of the surge is decreased. Accordingly, it is necessary to decrease weighted values for an area in which engine RPM is high, but to increase the weighted values for an area in which the engine RPM is low. By doing so, the degrees that the IMEP parameter, the PPP parameter, and the BD parameter respectively contribute to the index may be differently set according to the RPM.

D and E are tuning parameters to adjust the index of the present invention to 1. The values may be differently set for each engine.

Finally, the index proposed by the present disclosure is represented as follows:

[(max{COV_{IMEP},COVₘᵢₙ}/COV_{thd})^{A}+(max{PPP,PPPₘᵢₙ}/PPP_{thd})^{B}+(max{BD,BDₘᵢₙ}/BD_{thd})^{C}]×D/n^{E}

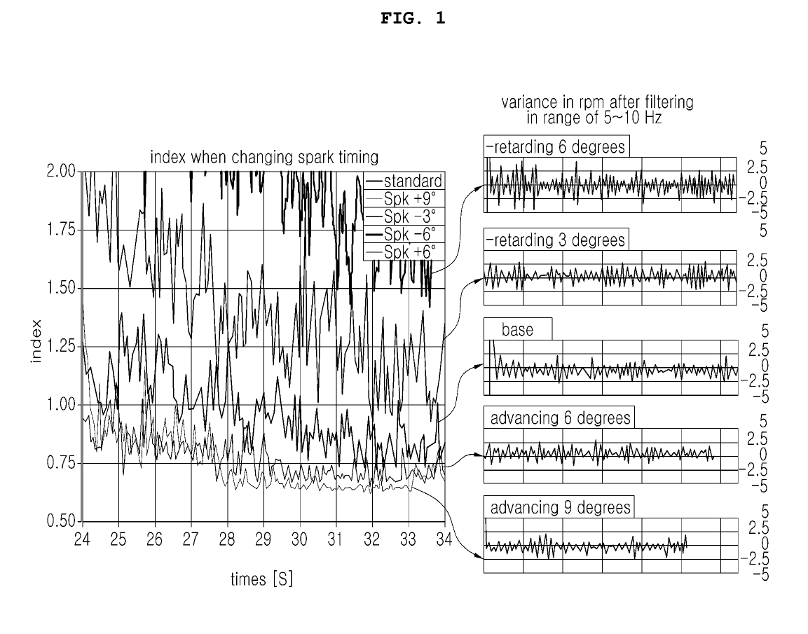

FIG. 1 is a graph illustrating a variance in the index to a variance in RPM of a vehicle when changing ignition timing using the index of the present disclosure in which values are set as A=3, B=4, C=1.5, D=6.3, and E=0.38 for the above equation. As shown in FIG. 1, the variance in RPM of the vehicle corresponds to the variance in the index of the present disclosure.

That is, the calculated index corresponds to the degree of the variance in RPM of the engine. As the value of the index is high, the variance in RPM is high. On the contrary, as the index value is low, the variance in RPM is low.

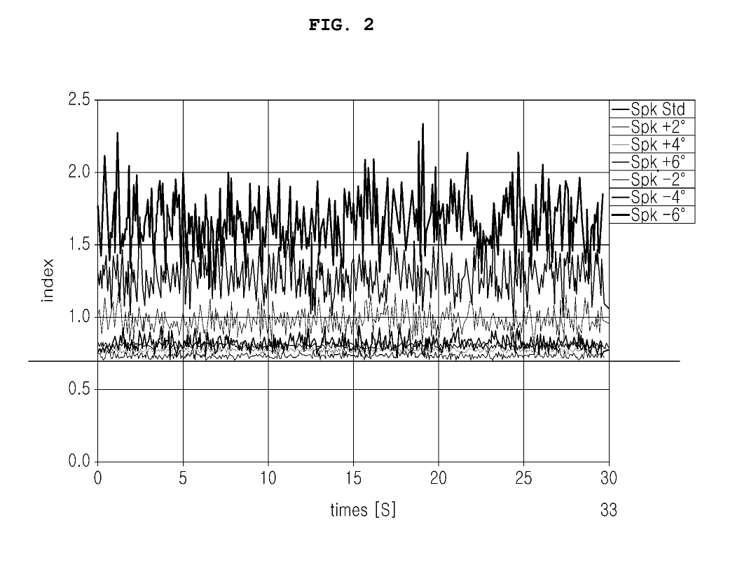

FIG. 2 is a graph illustrating a result when applying a lower limit of each parameter as A=3, B=4, C=1.5, D=6.3, E=0.38, COVₘᵢₙ, =2.2, PPPₘᵢₙ, =28, BDₘᵢₙ, =27, COV_{thd}=2.8, PPP_{thd}=33 degrees, and BD_{thd}=33 degrees. As shown in FIG. 2, the value of the index of the present invention converges into near 0.7 by setting the parameters as the lower limits thereof.

Although the embodiments of the present inventive concept have been disclosed for illustrative purposes, those skilled in the art will appreciate that various modifications, additions and substitutions are possible, without departing from the scope and spirit of the invention as disclosed in the accompanying claims.

What is claimed is:

1. A method for detecting a surge level in a vehicle based on a combustion pressure inside a cylinder, the method comprising:
determining an indicated mean effective pressure (IMEP) parameter which determines stability of combustion according to a variance in a covariance of IMEP;
determining a peak cylinder pressure position (PPP) parameter which varies the covariance of IMEP and which determines the stability of combustion according to a variance in an angle of rotation of a crank when the combustion pressure in the cylinder reaches a highest point;
determining a burn duration (BD) parameter which varies both the angle of rotation of the crank when the combustion pressure in the cylinder reaches the highest point and the covariance of IMEP and which determines the stability of combustion according to the variance in the angle of rotation when a set range of amount of fuel is burned in the cylinder; and
determining a revolutions per minute (RPM) parameter which determines a surge level according to a variance in an RPM of an engine.

2. The method of claim 1, wherein the surge level is calculated using the following equation:
[(IMEP parameter)+(PPP parameter)+(BD parameter)]×(RPM parameter)

3. The method of claim 2, wherein the IMEP parameter is implemented by the following equation:
(max{COV_{IMEP},COVₘᵢₙ}/COV_{thd})^{A},
where IMEP denotes the indicated mean combustion pressure in the cylinder, COV_{IMEP} denotes the covariance of the IMEP, COVₘᵢₙ denotes a set minimum value of the COV_{IMEP}, COV_{thd} denotes a set threshold value of the COV_{IMEP} to prevent occurrence of a surge, and A denotes a degree of contribution of the IMEP parameter to the surge.

4. The method of claim 3, wherein the COVₘᵢₙ determines whether or not the surge occurs in the vehicle even though the IMEP parameter has a smaller value than those of the PPP parameter and the BD parameter.

5. The method of claim 2, wherein the PPP parameter is implemented by the following equation:
(max{PPP,PPPₘᵢₙ}/PPP_{thd})^{B},
where PPP denotes the angle of rotation of the crank when the combustion pressure in the cylinder reaches the highest point, PPPₘᵢₙ denotes a set minimum value of PPP, PPP_{thd} denotes a set threshold value of PPP to prevent occurrence of the surge, and B denotes a degree of contribution of the PPP to the surge in the vehicle.

6. The method of claim 5, wherein PPPₘᵢₙ determines whether or not the surge occurs in the vehicle even though the PPP parameter has a value smaller than those of the IMEP parameter and BD parameter.

7. The method of claim 2, wherein the BD parameter is implemented by the following Equation:
(max{BD,BDₘᵢₙ}/BD_{thd})^{C},
where BD denotes the variance in the angle of rotation of the crank when the set range of amount of fuel is burned in the cylinder, BDₘᵢₙ denotes a set minimum value of BD, BD_{thd} denotes a threshold value of the BD to prevent occurrence of the surge, and C denotes a degree of contribution of the BD parameter to the surge in the vehicle.

8. The method of claim 7, wherein the BD is the variance of the angle that the crank rotates from a point in which an amount of fuel burned in the cylinder is 5% of a total amount of the fuel to a point in which an amount of the fuel burned in the cylinder is 90% of the total amount of the fuel.

9. The method of claim 8, wherein BDₘᵢₙ determines whether or not the surge occurs in the vehicle even though the BD parameter has a smaller value than those of the IMEP parameter and the PPP parameter.

10. The method of claim 2, wherein the RPM parameter is implemented by the following Equation:
D/n^{E},
where n denotes the RPM of the engine, and D and E denote variables that change according to the engine.

11. The method of claim 10, wherein the RPM parameter determines the surge level in which the IMEP parameter, PPP parameter, and BD parameter decrease as the RPM of the engine increases.
